(19) United States
(12) Patent Application Publication
(10) Pub. No.: US 2024/0304947 A1
(43) Pub. Date: Sep. 12, 2024

(54) SECONDARY BATTERY

(71) Applicant: Samsung SDI Co., Ltd., Yongin-si (KR)

(72) Inventors: Jin Nam KIM, Yongin-si (KR); Chang Hun CHO, Yongin-si (KR)

(21) Appl. No.: 18/668,733

(22) Filed: May 20, 2024

Related U.S. Application Data
(63) Continuation of application No. 16/937,430, filed on Jul. 23, 2020.

(30) Foreign Application Priority Data
Sep. 30, 2019 (KR) 10-2019-0120630

(51) Int. Cl. H01M 50/446; H01M 4/66; H01M 50/46

(52) U.S. Cl. CPC H01M 50/446; H01M 4/667; H01M 50/46

(57) ABSTRACT

A secondary battery includes an electrode assembly including a positive electrode plate having a positive electrode non-coating portion, a negative electrode plate having a negative electrode non-coating portion, and a separator between the positive and negative electrode plates. The positive and negative electrode non-coating portions are exposed at opposite sides of the electrode assembly. The secondary battery also includes a case having a top opening and an internal space accommodating the electrode assembly, a cap plate sealing the top opening of the case, a positive electrode current collector plate perpendicular and welded to the positive electrode non-coating portion, a negative electrode current collector plate perpendicular and welded to the negative electrode non-coating portion; a positive electrode terminal on the cap plate and electrically connected to the positive electrode current collector plate, and a negative electrode terminal on the cap plate and electrically connected to the negative electrode current collector plate.

### CROSS-REFERENCE TO RELATED APPLICATION(S)

This application is a continuation of U.S. patent application Ser. No. 16/937,430, filed Jul. 23, 2020, which claims priority to and the benefit of Korean Patent Application No. 10-2019-0120630 filed on Sep. 30, 2019 in the Korean Intellectual Property Office, the entire contents of both of which are incorporated herein by reference.

### BACKGROUND

### 1. Field

Aspects of embodiments of the present disclosure relate to a secondary battery.

### 2. Description of the Related Art

Unlike a primary battery, a secondary battery can be repeatedly charged and discharged. A low-capacity secondary battery is used for various small portable electronic devices such as mobile phones, camcorders, or laptop computers, and a high-capacity secondary battery is extensively used as a power source for driving electronic devices such as a motor of a hybrid car or an electric car, a power storage cell, and the like.

In addition, the secondary battery may be classified as a cylindrical type, a prismatic type or a pouch type according to the external shape of the secondary battery. Among others, a prismatic secondary battery may include an electrode assembly, a case having a rectangular parallelepiped shape and accommodating the electrode assembly and an electrolyte, a cap plate sealing the case, and electrode terminals installed on the cap plate.

The above information disclosed in this Background section is only for enhancement of understanding of the background of the described technology and therefore it may contain information that does not form the prior art that is already known in this country to a person of ordinary skill in the art.

### SUMMARY

Embodiments of the present disclosure related to a secondary battery which is capable of increasing battery capacity and improving welding quality compared to related art secondary batteries.

According to embodiments of the present disclosure, a secondary battery

includes an electrode assembly including a positive electrode plate having a positive electrode non-coating portion, a negative electrode plate having a negative electrode non-coating portion, and a separator between the positive electrode plate and the negative electrode plate, the positive electrode non-coating portion and the negative electrode non-coating portion being exposed at opposite sides of the electrode assembly, a case having a top opening and an internal space accommodating the electrode assembly, a cap plate sealing the top opening of the case, a positive electrode current collector plate perpendicular and welded to the positive electrode non-coating portion, a negative electrode current collector plate perpendicular and welded to the negative electrode non-coating portion, a positive electrode terminal on the cap plate and electrically connected to the positive electrode current collector plate, and a negative electrode terminal on the cap plate and electrically connected to the negative electrode current collector plate.

In addition, the electrode assembly may also include a second separator and the positive electrode plate, the separator, the negative electrode plate and the second separator may be sequentially stacked.

In addition, the positive electrode current collector plate and/or the negative electrode current collector plate may have an area equal to the cross-sectional area of the electrode assembly.

In addition, the electrode assembly may be wound about a winding axis into a jelly roll configuration such that the positive electrode non-coating portion is exposed at one end of the winding axis, and the negative electrode non-coating portion is exposed to the other end of the winding axis, and the winding axis is horizontally aligned on the top opening.

In addition, the electrode assembly may have a cross section elongated in a top-down direction, the cross section being perpendicular to the winding axis, and the electrode assembly may include a series of electrode assemblies that are stacked on each other along a direction transverse to the top-down direction.

In addition, the positive electrode current collector plate and/or the negative electrode current collector plate may have an area equivalent to the overall area of cross sections of the series of electrode assemblies.

In addition, the positive electrode non-coating portion may be in line-contact with the positive electrode current collector plate, and the negative electrode non-coating portion may be in line-contact with the negative electrode current collector plate.

In addition, an entirety of the positive electrode current collector plate may contact an entirety of the positive electrode non-coating portion, and an entirety of the negative electrode current collector plate may contact an entirety of the negative electrode non-coating portion.

As described above, according to embodiments of the present disclosure, since an electrode non-coating portion is in line-contact with an electrode current collector plate, the area of the electrode non-coating portion can be reduced, compared to a related art secondary battery where the electrode non-coating portion is in surface-contact with the electrode current collector plate, thereby increasing battery capacity, and ultimately simplifying the manufacturing process.

### BRIEF DESCRIPTION OF DRAWINGS

FIG. 1 is a perspective view of a secondary battery according to an embodiment of the present disclosure.

FIG. 2 is an exploded view of the secondary battery according to an embodiment of the present disclosure.

FIG. 3 is an exploded view of a secondary battery according to another embodiment of the present disclosure.

### DETAILED DESCRIPTION

Hereinafter, embodiments of the present disclosure will be described in detail.

The embodiments of the present disclosure, however, may be modified in many different forms and should not be construed as being limited to the example (or exemplary) embodiments set forth herein. Rather, these example embodiments are provided so that this disclosure will be thorough and complete and will convey the aspects and features of the present disclosure to those skilled in the art.

In addition, in the accompanying drawings, sizes or thicknesses of various components are exaggerated for brevity and clarity. Like numbers refer to like elements throughout. As used herein, the term “and/or” includes any and all combinations of one or more of the associated listed items. In addition, it will be understood that when an element A is referred to as being “connected to” an element B, the element A can be directly connected to the element B or an intervening element C may be present therebetween such that the element A and the element B are indirectly connected to each other.

The terminology used herein is for the purpose of describing particular embodiments only and is not intended to be limiting of the disclosure. As used herein, the singular forms are intended to include the plural forms as well, unless the context clearly indicates otherwise. It will be further understood that the terms that the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof.

It will be understood that, although the terms first, second, etc. may be used herein to describe various members, elements, regions, layers and/or sections, these members, elements, regions, layers and/or sections should not be limited by these terms. These terms are only used to distinguish one member, element, region, layer and/or section from another. Thus, for example, a first member, a first element, a first region, a first layer and/or a first section discussed below could be termed a second member, a second element, a second region, a second layer and/or a second section without departing from the teachings of the present disclosure.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the element or feature in the figures is turned over, elements described as “below” or “beneath” other elements or features would then be oriented “on” or “above” the other elements or features. Thus, the exemplary term “below” can encompass both an orientation of above and below.

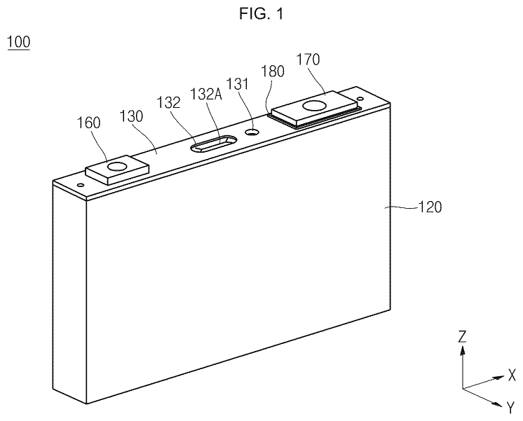

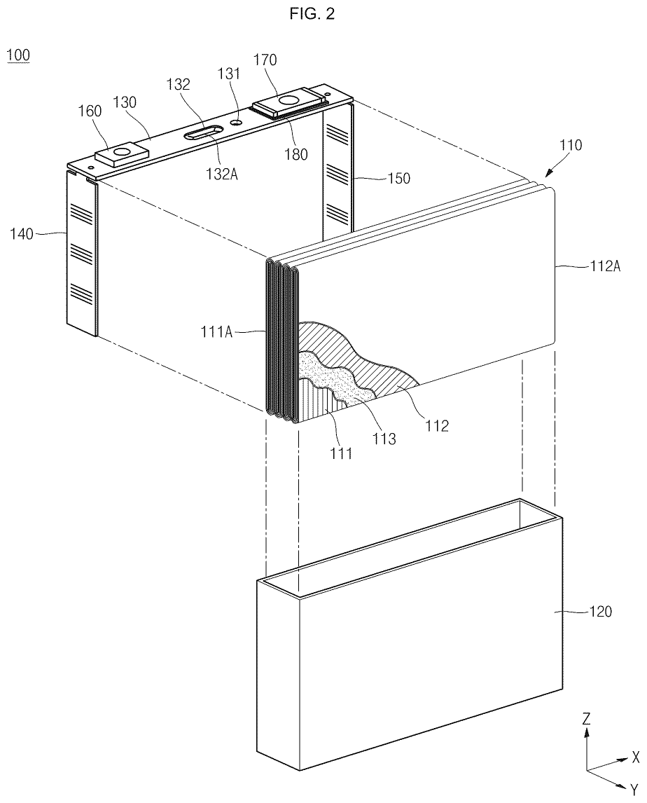

FIG. 1 is a perspective view of a secondary battery 100 according to an embodiment of the present disclosure, and FIG. 2 is an exploded view of the secondary 100 battery according to an embodiment of the present disclosure.

Referring to FIGS. 1 and 2, the secondary battery 100 according to an embodiment includes an electrode assembly 110, a case 120, a cap plate 130, a positive electrode current collector plate 140, a negative electrode current collector plate 150, a positive electrode terminal 160, and a negative electrode terminal 170.

The electrode assembly 110 includes a positive electrode plate 111, a negative electrode plate 112, and a separator 113 between the positive electrode plate 111 and the negative electrode plate 112.

The positive electrode plate 111 has a positive electrode coating portion with a positive electrode active material coated thereon, and a positive electrode non-coating portion 111A without a positive electrode active material coated thereon. The positive electrode coating portion (including, for example, a transition metal oxide) is formed on a positive electrode current collector made of, for example, an aluminum foil, and the positive electrode non-coating portion 111A is formed along one side of the positive electrode current collector.

In addition, the negative electrode plate 112 has a negative electrode coating portion with a negative electrode active material coated thereon, and a negative electrode non-coating portion 112A without a negative electrode active material coated thereon. The negative electrode coating portion (including, for example, carbon or graphite) is formed on a negative electrode current collector made of, for example, a copper or nickel foil, and the negative electrode non-coating portion 112A is formed along one side of the negative electrode current collector.

The separator 113 is an insulator and may be made of, for example, polyethylene, polypropylene, or a composite film of polypropylene and polyethylene. The separator 113 is located between the positive electrode plate 111 and the negative electrode plate 112 to prevent a short circuit from occurring between the positive electrode plate 111 and the negative electrode plate 112 and to allow the movement of lithium ions.

The electrode assembly 110, including the positive electrode plate 111, the negative electrode plate 112 and the separator 113, is wound about a winding axis into a so-called jelly roll configuration. In one or more embodiments, the positive electrode non-coating portion 111A is wound about the winding axis so as to be exposed at one end of the winding axis, and the negative electrode non-coating portion 112A is wound about the winding axis so as to be exposed at the other end of the winding axis. In FIG. 2, the winding axis is aligned along the X-axis direction, the positive electrode non-coating portion 111A is exposed at the minus (−) side in the X-axis direction, and the negative electrode non-coating portion 112A is exposed at the plus (+) side in the X-axis direction. Accordingly, in the illustrated embodiment, the winding axis is horizontally aligned with the top opening of the case 120.

In addition, in one or more embodiments, a cross-sectional shape of the electrode assembly 110 in a plane perpendicular to the winding axis (e.g., a Y-Z plane in which the winding axis is elongated along the Z-axis direction) may be a circle, an ellipse, or an oblong shape. Accordingly, in one or more embodiments, the electrode assembly 100 has a cross section in a plane perpendicular to the winding axis (e.g., a Y-Z plane) that is elongated in a top-down direction (i.e., a direction along the Z-axis).

Additionally, in the illustrated embodiment, the plurality of electrode assemblies 100 are stacked along a direction transverse to the top-down direction (e.g., the plurality of electrode assemblies 100 are stacked in the Y-axis direction).

Additionally, the electrode assembly 110 may include a plurality of electrode assemblies, which are adjacently stacked one on another along the Y-axis direction.

The case 120 is shaped of a substantially rectangular parallelepiped having an internal space and a top opening (e.g., an open top). Accordingly, the internal space of the case 120 may serve to accommodate the electrode assembly 110 and an electrolyte.

The electrolyte may include, for example, an organic solvent such as ethylene carbonate (EC), propylene carbonate (PC), diethyl carbonate (DEC), dimethyl carbonate (DMC), ethyl methyl carbonate (EMC), and a lithium salt such as LiPF6 or LibF4.

The cap plate 130 is coupled to a top end of the case 120 and seals the top surface of the case 120 (e.g., the cap plate 130 covers or closes the top opening of the case 12). The case 120 and the cap plate 130 may be made of, for example, aluminum, and welded together.

In addition, the cap plate 130 may have an electrolyte injection hole and a vent hole.

The electrolyte injection hole is provided for injecting an electrolyte into the interior space of the case 120 after the cap plate 130 is coupled to the case 120. Once the electrolyte is injected, the electrolyte injection hole is sealed by a plug 131.

The vent hole is configured to discharge or vent internal gases generated inside the case 120 and thereby prevent an explosion due to the internal gases generated inside the case 120. The vent hole is sealed by a vent member 132 at normal times, and is opened as the vent member 132 is naturally ruptured when the internal pressure of the case 120 reaches a certain level (e.g., the vent member 132 is configured to rupture when a threshold internal pressure is reached inside the case 120). In addition, the vent member 132 may have a notch 132A formed therein that is configured to facilitate the rupturing of the vent member 132 around the notch 132A.

The positive electrode current collector plate 140 may be formed of, for example, an aluminum plate, and may be perpendicular to the positive electrode non-coating portion 111A. The positive electrode current collector plate 140 may be welded to the positive electrode non-coating portion 111A. In one or more embodiments, the positive electrode non-coating portion 111A is in line-contact with the positive electrode current collector plate 140. With this structure, the area of the positive electrode non-coating portion 111A may be reduced, compared to an embodiment in which the positive electrode non-coating portion 111A is in surface-contact with the positive electrode current collector plate 140, thereby increasing battery capacity of the secondary battery 100.

In addition, the positive electrode current collector plate 140 may be formed to have an area equivalent or substantially equivalent to an area of the overall cross sections of the positive electrode non-coating portions 111A of the plurality of electrode assemblies 110, and thus an entirety or substantially an entirety of the positive electrode current collector plate 140 may contact an entirety or substantially an entirety of the positive electrode non-coating portions 111A of the plurality of electrode assemblies 110. Accordingly, resistance between the positive electrode non-coating portion 111A and the positive electrode current collector plate 140 may be minimized or at least reduced compared to a second battery not having this configuration.

In one or more embodiments, the positive electrode current collector plate 140 may be welded to the positive electrode non-coating portion 111A by a laser. In this embodiment, during the task of laser welding the positive electrode current collector plate 140 to the positive electrode non-coating portion 111A, the laser may be irradiated along the Y-axis direction. In other words, the laser welding line joining the positive electrode current collector plate 140 to the positive electrode non-coating portion 111A may be formed along the Y-axis direction. In one or more embodiments, the laser may be irradiated with an appropriate intensity so as not to completely fuse the positive electrode current collector plate 140 or the positive electrode non-coating portion 111A. If the laser irradiated is strong enough to completely fuse the positive electrode current collector plate 140, foreign substances (for example, spattered substances) may be induced to the electrode assembly 110, which may result in a short circuit or other damage to the secondary battery 100. However, if the laser irradiated is not strong enough to completely fuse the positive electrode current collector plate 140, the above-described problem(s) can be avoided.

In addition, since the electrode assembly 110 is wound into a jelly roll configuration, the self-supporting ability of the positive electrode non-coating portion 111A may be increased by the curvature thereof. Therefore, the positive electrode non-coating portion 111A may be prevented from being undesirably deformed when the positive electrode current collector plate 140 is pressed against the positive electrode non-coating portion 111A.

Moreover, since the electrode assembly 110 comprises a plurality of electrode assemblies, each of the plurality of electrode assemblies may be relatively narrow and long for a given interior volume of the case 120, compared to an embodiment in which the electrode assembly 110 includes only a single electrode assembly. The self-supporting ability of the positive electrode non-coating portion 111A may be further increased by allowing the positive electrode non-coating portion 111A to have larger curvatures at top and bottom ends thereof, which also improves weld quality between the positive electrode non-coating portion 111A and the positive electrode current collector plate 140.

The negative electrode current collector plate 150 may be formed of, for example, a copper or nickel plate, and may be perpendicular to the negative electrode non-coating portion 112A. The negative electrode current collector plate 150 may be welded to the negative electrode non-coating portion 112A.

The negative electrode current collector plate 150 may also be formed to have an area equivalent or substantially equivalent to an area of the overall cross sections of negative electrode non-coating portions 112A of a plurality of electrode assemblies 110, and thus an entirety or substantially an entirety of the negative electrode current collector plate 150 may contact an entirety or substantially an entirety of the negative electrode non-coating portions 112A of the plurality of electrode assemblies 110.

In one or more embodiments, the negative electrode current collector plate 150 may be welded to the negative electrode non-coating portion 112A by a laser. In this embodiment, during the task of laser welding the negative electrode current collector plate 150 to the negative electrode non-coating portion 112A, the laser may be irradiated along the Y-axis direction with an appropriate intensity so as not to completely fuse the negative electrode current collector plate 150 or the negative electrode non-coating portion 112A.

Since the resulting effects are substantially the same as those described above with respect to the positive electrode current collector plate 140 and the positive electrode non-coating portion 111A, a repeated description thereof will be omitted.

The positive electrode terminal 160 is installed on the cap plate 130 and is electrically connected to the positive electrode current collector plate 140.

In addition, the negative electrode terminal 170 is installed on the cap plate 130 and is electrically connected to the negative electrode current collector plate 150.

If the positive electrode terminal 160 is in contact with the cap plate 130, an insulation member 180 is provided between the negative electrode terminal 170 and the cap plate 130 (e.g., the negative electrode terminal 170 is spaced apart, and electrically isolated, from the cap plate 130 by the insulation member 180) to prevent a short circuit.

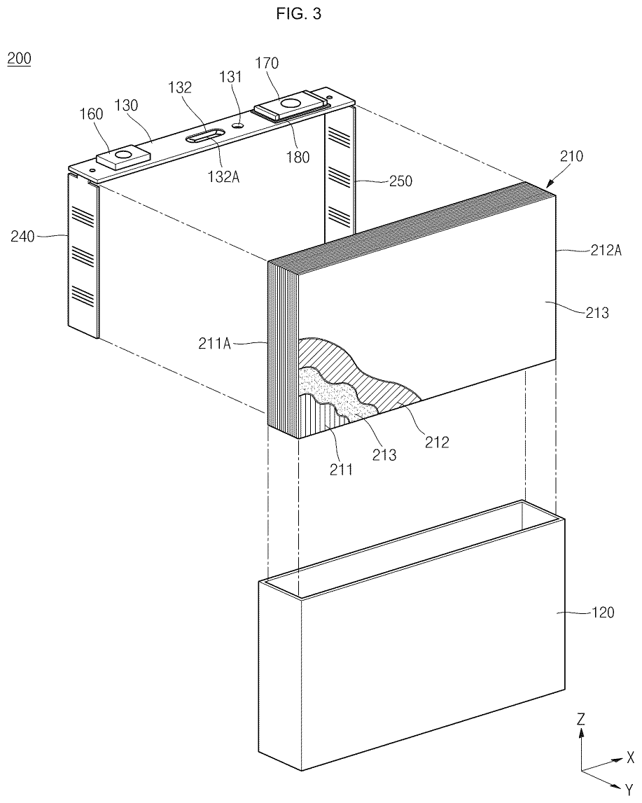

FIG. 3 is an exploded view of a secondary battery 200 according to another embodiment of the present disclosure.

The secondary battery 200 according to another embodiment differs from the secondary battery 100 described above with reference to FIGS. 1 and 2 in that the former includes an electrode assembly 210 constructed in a stack type, and the other details are substantially the same in both embodiments, and thus repeated descriptions of the common components and/or features will be omitted. The common components and/or features of the embodiment illustrated in FIG. 3 and the embodiment illustrated in FIGS. 1-2 are identified with the same reference numbers.

Referring to FIG. 3, the electrode assembly 210 includes a positive electrode plate 211, a separator 213, a negative electrode plate 212, and another separator 213 sequentially stacked in that order. In the resulting stack, a positive electrode non-coating portion 211A and a negative electrode non-coating portion 212A are exposed on opposite sides. In FIG. 3, the positive electrode non-coating portion 211A is exposed at the minus (−) side in the X-axis direction and the negative electrode non-coating portion 212A exposed at the plus (+) side in the X-axis direction.

In the illustrated embodiment, the secondary battery 200 also includes a positive electrode current collector plate 240 and a negative electrode current collector plate 250 coupled to the cap plate 130. The positive electrode current collector plate 240 may be perpendicular to the positive electrode non-coating portion 211A, and the positive electrode current collector plate 240 may be welded to the positive electrode non-coating portion 211A (e.g., by a laser). The positive electrode current collector plate 240 has an area equivalent or substantially equivalent to a cross-sectional area of the electrode assembly 210 in the Y-Z plane.

The negative electrode current collector plate 250 may be perpendicular to the negative electrode non-coating portion 212A, and the negative electrode current collector plate 250 may be welded to the negative electrode non-coating portion 212A (e.g., by a laser). The negative electrode current collector plate 250 has an area equivalent or substantially equivalent to a cross-sectional area of the electrode assembly 210 in the Y-Z plane.

In one or more embodiments, the positive electrode current collector plate 240 and the negative electrode current collector plate 250 may each have a thickness of, for example, greater than or equal to approximately 1 mm.

While the foregoing embodiment has been described to practice the

secondary battery of the present disclosure, it will be understood by those of ordinary skill in the art that various changes in form and details may be made therein without departing from the spirit and scope of the present disclosure as defined by the following claims.

### Explanation of Reference Numerals

100, 200: Secondary battery
110, 210: Electrode assembly
111, 211: Positive electrode plate
111A, 211A: Positive electrode non-coating portion
112, 212: Negative electrode plate
112A, 212A: Negative electrode non-coating portion
113, 213: Separator
120: Case
130: Cap plate
131: Plug
132: Vent member
132A: Notch
140, 240: Positive electrode current collector plate
150, 250: Negative electrode current collector plate
160: Positive electrode terminal
170: Negative electrode terminal
180: Insulation member

What is claimed is:

1. A secondary battery comprising:
an electrode assembly comprising a positive electrode plate having a positive electrode non-coating portion exposed on one side of the electrode assembly, a first separator, a negative electrode plate having a negative electrode non-coating portion exposed on another side of the electrode assembly, and a second separator, wherein the electrode assembly is a stack type electrode assembly;
a case having an open top surface, the case accommodating the electrode assembly;
a cap plate closing the open top surface of the case;
a positive electrode current collector plate perpendicular to the positive electrode non-coating portion and welded to the positive electrode non-coating portion;
a negative electrode current collector plate perpendicular to the negative electrode non-coating portion and welded to the negative electrode non-coating portion;
a positive electrode terminal on the cap plate and electrically connected to the positive electrode current collector plate; and
a negative electrode terminal on the cap plate and electrically connected to the negative electrode current collector plate.

2. The secondary battery as claimed in claim 1, wherein at least one of the positive electrode current collector plate or the negative electrode current collector plate has a thickness of approximately 1 mm or more.

3. The secondary battery as claimed in claim 1, wherein the cap plate has a vent hole, and wherein the vent hole is sealed by a vent member.

4. The secondary battery as claimed in claim 3, wherein the vent member has a notch.

5. The secondary battery as claimed in claim 1, wherein the positive electrode current collector plate is welded to the positive electrode non-coating portion along at least one first laser welding line, and/or
wherein the negative electrode current collector plate is welded to the negative electrode non-coating portion along at least one second laser welding line.

6. The secondary battery as claimed in claim 5, wherein the at least one first laser welding line extends in a direction perpendicular to an edge of the positive electrode non-coating portion, and/or
wherein the at least one second laser welding line extends in a direction perpendicular to an edge of the negative electrode non-coating portion.

7. The secondary battery as claimed in claim 6, wherein the at least one first laser welding line comprises a plurality of first laser welding lines, to the plurality of first laser welding lines being spaced apart along a direction parallel to the edge of the positive electrode non-coating portion, and/or
wherein the at least one second laser welding line comprises a plurality of second laser welding lines, the plurality of second laser welding lines being spaced apart along a direction parallel to the edge of the negative electrode non-coating portion.

8. The secondary battery as claimed in claim 5, wherein the at least one first laser welding line extends continuously in a direction perpendicular to an edge of the positive electrode non-coating portion, and/or wherein the at least one second laser welding line extends continuously in a direction perpendicular to an edge of the negative electrode non-coating portion.

9. The secondary battery as claimed in claim 8, wherein the at least one first laser welding line comprises a plurality of first laser welding lines, to the plurality of first laser welding lines being spaced apart along a direction parallel to the edge of the positive electrode non-coating portion, and/or
wherein the at least one second laser welding line comprises a plurality of second laser welding lines, the plurality of second laser welding lines being spaced apart along a direction parallel to the edge of the negative electrode non-coating portion.

10. The secondary battery as claimed in claim 1, wherein the positive electrode current collector plate is in line contact with an edge of the positive electrode non-coating portion, and/or
wherein the negative electrode current collector plate is in line contact with an edge of the negative electrode non-coating portion.

11. The secondary battery as claimed claim 1, wherein at least one of the positive electrode current collector plate or the negative electrode current collector plate has a rectangular plate shape.

12. The secondary battery as claimed claim 11, wherein at least one of one side or the another side of the electrode assembly has a rectangular shape.

13. The secondary battery as claimed claim 11, wherein the positive electrode current collector plate has an area corresponding to an area of one side of the electrode assembly, and/or wherein the negative electrode current collector plate has an area corresponding to an area of the another side of the electrode assembly.

14. The secondary battery as claimed claim 11, wherein the positive electrode current collector plate does not have a portion extending beyond an area of the one side of the electrode assembly, and/or
wherein the negative electrode current collector plate does not have a portion extending beyond an area of the another side of the electrode assembly.

15. The secondary battery as claimed claim 1, wherein the cap plate has an electrolyte injection hole, and wherein the electrolyte injection hole is sealed with a plug.

16. The secondary battery as claimed claim 1, comprising an insulation member between the cap plate and the negative electrode terminal.
